(19) United States
(12) Patent Application Publication
(10) Pub. No.: US 2019/0060909 A1
(43) Pub. Date: Feb. 28, 2019

(54) LABORATORY TEST TUBE RACK AND ASSOCIATED DEVICES, SYSTEMS AND METHODS OF USE

(71) Applicant: University of Iowa Research Foundation, Iowa City, IA (US)

(72) Inventors: Michael Wardenburg, Williamsburg, IA (US); Marcus Nashelsky, Iowa City, IA (US); Lynnette Kenne, Coralville, IA (US)

(21) Appl. No.: 16/112,084

(22) Filed: Aug. 24, 2018

Related U.S. Application Data
(60) Provisional application No. 62/549,712, filed on Aug. 24, 2017.

(51) Int. Cl. B01L 9/06; B01L 3/00

(52) U.S. Cl. CPC B01L 9/06; B01L 3/56; B01L 3/50

(57) ABSTRACT

The disclosed devices, systems and methods related to the use of a test tube rack to assist with withdrawal of a needle from a container. The rack has a plurality of notches on a top shelf and corresponding openings on a second shelf that allow for the movement of a container stored therein between positions so as to prevent needle sticks and allow for one-handed operation.

### CROSS-REFERENCE TO RELATED APPLICATION(S)

This application claims priority to U.S. Provisional Application No. 62/549,712 filed Aug. 24, 2017 and entitled “Laboratory Test Tube Rack and Associated Devices, Systems and Methods of Use,” which is hereby incorporated by reference in its entirety under 35 U.S.C. § 119(e).

### TECHNICAL FIELD

The various implementations disclosed herein relate to test tube racks and associated systems and methods.

### BACKGROUND

The disclosure relates generally to test tube racks, systems, and methods allowing for safe, one-handed withdrawal of a needle from a test tube. Current test tube racks are designed to hold test tubes in separate physical spaces for vertical storage. These test tube racks lack a frame that allows for a needle to be withdrawn from a test tube without the use of another device, such as a human hand, to hold the test tube in place. Using a hand to hold the test tube in place while a needle is withdrawn from the test tube increases the likelihood of a needle stick injury, which can result in percutaneous injury or percutaneous exposure to infectious diseases.

Thus, there is a need in the art for a test tube rack that will hold a test tube in place while a needle is withdrawn without the use of another device (e.g., a hand), thereby reducing the occupational hazard created by contaminated needle stick injuries.

### BRIEF SUMMARY

The disclosure relates generally to test tube racks, systems, and methods allowing for safe, one-handed withdrawal of a needle from a test tube. Discussed herein are various implementations of a test tube rack, wherein the device comprises a frame, wherein the frame is configured to hold a container in place while a needle is withdrawn from the container, as well as associated systems and methods for use of the frame.

The term “needle” is used herein for brevity, but this not intended to limit the disclosure in any way. Certain non-limiting implementations of a needle include needle attached to a syringe, but can include other implementations that would be known to those of skill in the art and regularly found in laboratories.

A “container” as used herein relates to an elongate tube, wherein the elongate tube has a first end and a second end. The first end is defined by an opening that permits various compositions to be introduced and extracted from the container. In some implementations, the opening of the first end can be sealed by a variety of methods, including but not limited to insertion of a rubber stopper or plastic lid. Some non-limiting examples of containers include test tubes and vials.

A first Example includes a test tube rack including a frame. The test tube rack also includes at least one brace oriented substantially parallel with respect to a work surface. The test tube rack also includes at least one support oriented substantially perpendicular with respect to the work surface, where the one or more supports maintains spacing between the one or more braces. The test tube rack also includes at least one container. The test tube rack also includes where the frame is configured to hold the one or more containers in place while a needle is withdrawn from the container, such that a user's hand is protected from accidental needle sticks. Implementations may include one or more of the following features. The test tube rack where the one or more braces is included of: a first brace, where the first brace contains at least one of the following. The test tube rack may also include a plurality of storage openings, where the plurality of storage openings are used to store the one or more containers and/or one or more of the needle. The test tube rack may also include a plurality of notches, where each notch is sized such that each notch is large enough to accommodate the needle but not large enough to accommodate the container. The test tube rack may also include a second brace, where the second brace contains a plurality of openings oriented vertically below the plurality of notches, and where each opening accommodates one of the containers in a slightly angled position. The test tube rack may also include a third brace, where the third brace contains a plurality of storage depressions oriented vertically below the plurality of notches and the plurality of openings, and where each storage depression accommodates one of the containers in a substantially vertical position. The test tube rack may also include where each notch corresponds to the opening and the storage depression oriented vertically below that notch. The test tube rack where a user: selects one container from the one or more containers; places the one container in one of the plurality of openings of the second brace; inserts the needle into the one container to withdraw a sample. The test tube rack may also include shifts the one container from the one of the plurality of openings of the second brace into the corresponding storage depression of the third brace. The test tube rack may also include where the user uses the needle as a mechanism to shift the one container by positioning the needle so as to be disposed in the corresponding notch of the first brace. The test tube rack where the notch of the first brace permits the user to withdraw the needle from the container without using a hand to hold the container in place, thus preventing accidental needle sticks. The system where holding the container in place by the notch when the needle is removed prevents accidental needle sticks.

Another Example includes a system including: a needle, a container; and a test tube rack. In various implementations, the system also includes a frame included of a first brace, a second brace, and a third brace. The system also includes a notch, where the notch is situated on the first brace. The system also includes a opening, where the opening is situated on the second brace. The system also includes a storage depression, where the storage depression is situated on the third brace. The system also includes where the container is placed into the opening during needle insertion and is then moved to a substantially vertical position by shifting the needle such that it is disposed within the notch, where shifting the needle such that it is disposed within in the notch allows the container to rest on the storage depression. The system also includes and where the container is held in place by the notch when the needle is removed from the test tube. Various implementations may include one or more of the following features. The system where holding the container in place by the notch when the needle is removed prevents accidental needle sticks.

While multiple implementations are disclosed, still other implementations of the disclosure will become apparent to those skilled in the art from the following detailed description, which shows and describes illustrative implementations of the disclosed apparatus, systems, and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

The novel features are set forth with particularity in the claims that follow. A better understanding of the features and advantages will be obtained by reference to the following detailed description that sets forth illustrative implementations and the accompanying drawings of which:

FIG. 1 is a front view of an implementation of the test tube rack, wherein the container is in the needle insertion position.

FIG. 2A is a side view of an implementation of the test tube rack, wherein the container is in the angled position.

FIG. 2B is a side view of an implementation of the test tube rack, wherein the container is in the substantially vertical position.

FIG. 2C is a side view of an implementation of the test tube rack, wherein the container is in the substantially vertical position and the needle has been partially withdrawn.

FIG. 3A is a side view of an implementation of the test tube rack, wherein the container is in the angled position and a needle is being inserted.

FIG. 3B is a side view of an implementation of the test tube rack, wherein the container is in the substantially vertical position, with the needle inserted and the container is being urged distally.

FIG. 3C is a side view of an implementation of the test tube rack, wherein the container is in the substantially vertical position, having been urged distally via the needle.

FIG. 3D is a side view of an implementation of the test tube rack, wherein the container is in the substantially vertical position and the needle has been partially withdrawn.

FIG. 3E is a side view of an implementation of the test tube rack, wherein the container is in the angled position and a needle has been withdrawn.

FIG. 4A is a side view of an implementation of the test tube rack, wherein the container is in the storage position.

FIG. 4B is a top view of an implementation of the test tube rack, showing the storage depression.

FIG. 5A is a top view of an implementation of the test tube rack.

FIG. 5B is a perspective top view of a further exemplary depiction of the test tube rack.

### DETAILED DESCRIPTION

The disclosure relates generally to a test tube rack and associated systems and methods allowing for safe, one-handed withdrawal of a needle from a test tube. The various implementations disclosed or contemplated herein relate to the use of a frame, wherein the frame is configured to hold a container in place while a needle is withdrawn from the container, as well as associated systems and methods for use of the frame.

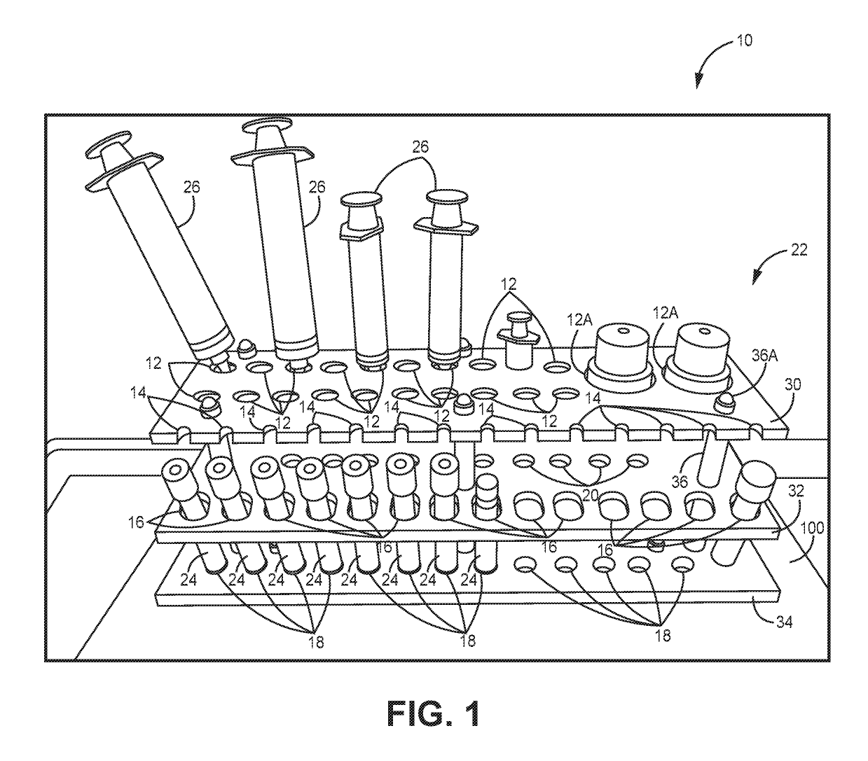

Turning to the drawings in more detail, FIG. 1 shows a test tube rack 10, according to one implementation. The test tube rack 10 according to these implementations has several openings 12, notches 14, elongate container openings 16, hemispheric depressions 18 and storage depressions 20 defined in a frame 22 having at least one elongate, planar brace or shelf 30, 32, 34 oriented substantially horizontally, that is parallel to the typical work surface 100 such as a lab bench 100. A variety of other openings 12A may be provided for use, as would be understood by those of skill in the art.

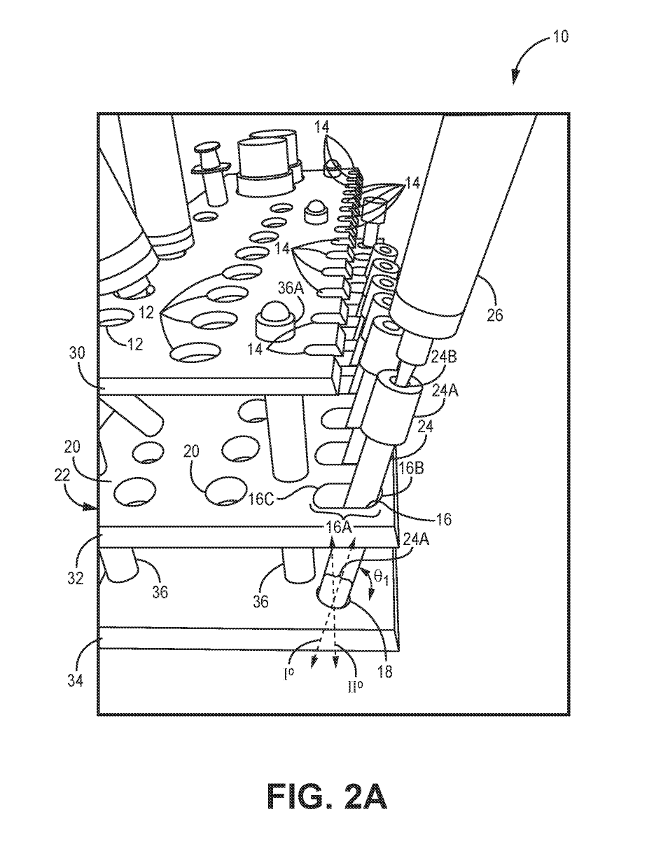

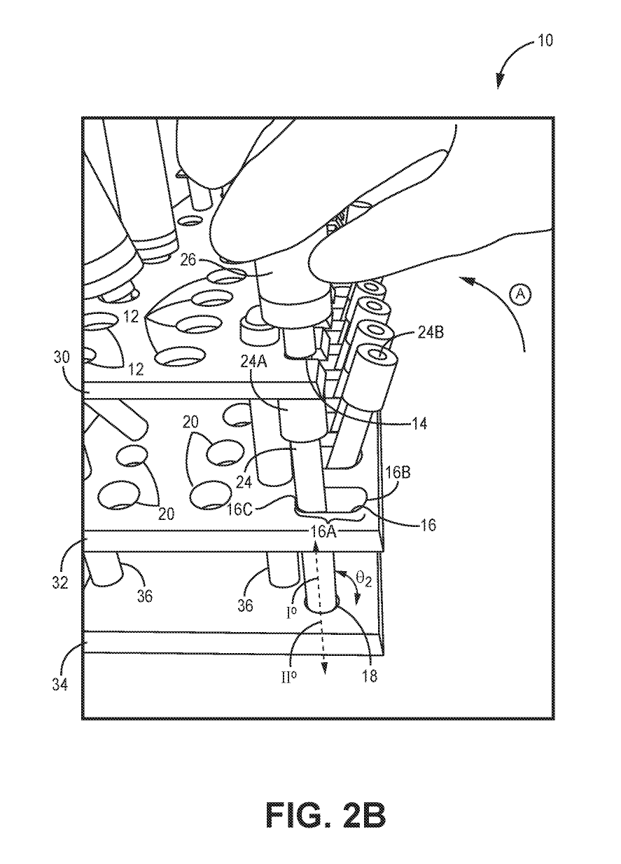

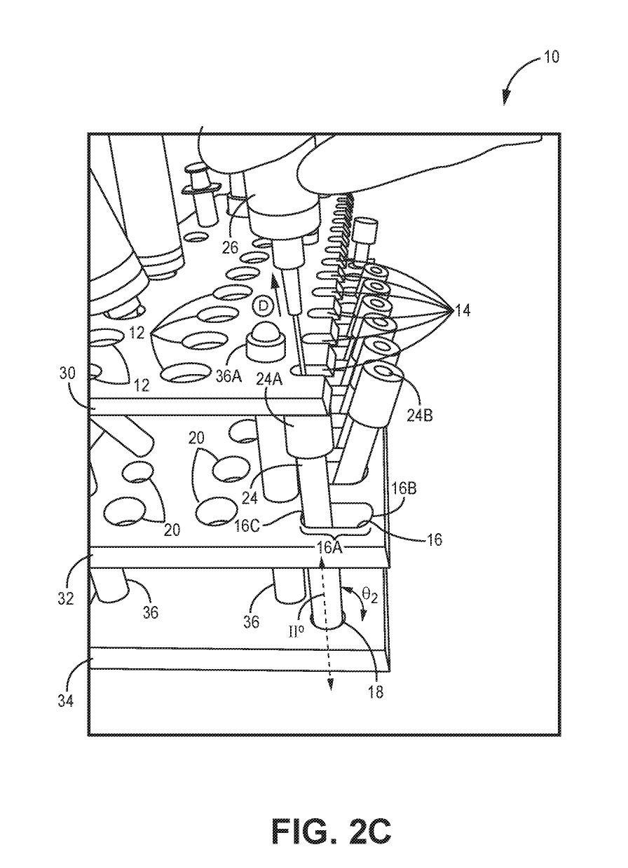

In various implementations, the first shelf 30, second shelf 32, and third shelf 34 are spaced substantially equidistantly and in parallel, supported by supports 36 with optional caps 36A. Further arrangements of shelves 30, 32, 34 are of course possible and would be well-understood by those of skill in the art. As is shown in the implementation of FIG. 2A, FIG. 2B and FIG. 2C, the top, or first shelf 30 may be narrower than the other shelves 32, 34 and offset for improved usability, as would be appreciated by those of skill in the art.

Importantly, and as shown in the implementations of FIG. 2A, FIG. 2B and FIG. 2C, the first shelf 30 includes a plurality of storage openings 12 and notches 14, wherein the notches 14 are sized or otherwise constructed and arranged to accommodate a typical needle 26 can but cannot accommodate a container 24, as is described below. I

In these implementations, a plurality of elongate container openings 16 are defined within the second shelf 32 and disposed substantially vertically below the notches 14. These elongate container openings 16 can be elongate rounded openings or slots having an opening width 16A defined by proximal 16B and distal 16C ends, wherein the overall opening width 16A exceeds that of the desired container width 24A so as to be constructed and arranged for lateral movement, as would be appreciated by one of skill in the art.

The second shelf 32 according to certain implementations also comprises storage depressions 20 substantially vertically below the storage openings 12 on which the second end of the container 24 can rest. In certain alternate implementations, the second shelf 32 does not contain storage depressions 20 but may contain corresponding openings for storage of containers, syringes and needles.

The third shelf 34 defines or otherwise includes depressions 18 such as substantially hemispherical depressions 18 in which the second end of the container 24 can rest. The hemispherical depression 18 according to these implementations are constructed and arranged to serve as a pivot point that allows the container 24 to be urged between the angled position and the substantially vertical position, as such, many shapes and sizes can be defined within the shelf. The hemispherical depression 18 according to certain implementations, optionally along with elongate container openings 16 can be sized to prevent the container 24 from tilting on more than one axis. It is understood that the depressions 18 are not critical to the use of the rack 10 according to certain implementations, but do provide certain advantages and stability to many such processes.

In use according to these implementations, in a first step and as shown in FIG. 1 and FIG. 2A, the test tube rack 10 is configured such that the upright container 24 is passed through the first elongate container opening 16 into the first depression 18 at on a first axis, or in an angled position θ₁. It is understood that in these and other implementations, while in the first position θ₁ the container is adjacent to or otherwise rests on the proximal end 16B of the opening 16A, as would be understood by those of skill in the art. It is appreciated that the container 24 of FIG. 1A is in the ready position.

In accordance with these implementations, the needle 26 is also inserted into the opening of the first end of the container 24 as shown in FIG. 2A by urging the needle 26 into the container 24, such as via a cap 24A through a seal 24B, as would be understood.

Continuing with use according to these implementations and as shown in FIG. 2B, in a subsequent step the user urges the container 24 distally from the angled position θ₁ to a second axis, or substantially vertical position θ₂, shown by reference arrow A. In certain implementations, while in the substantially vertical position θ₂ the container 24 is adjacent to, rests on or is otherwise abuts against the distal end 16C of the opening 16A.

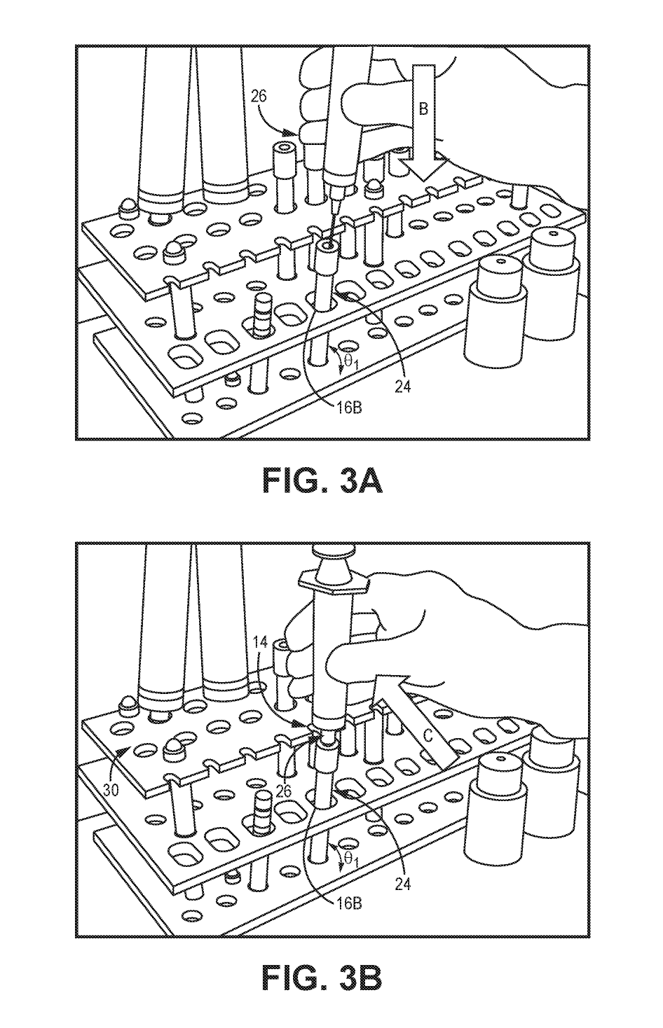

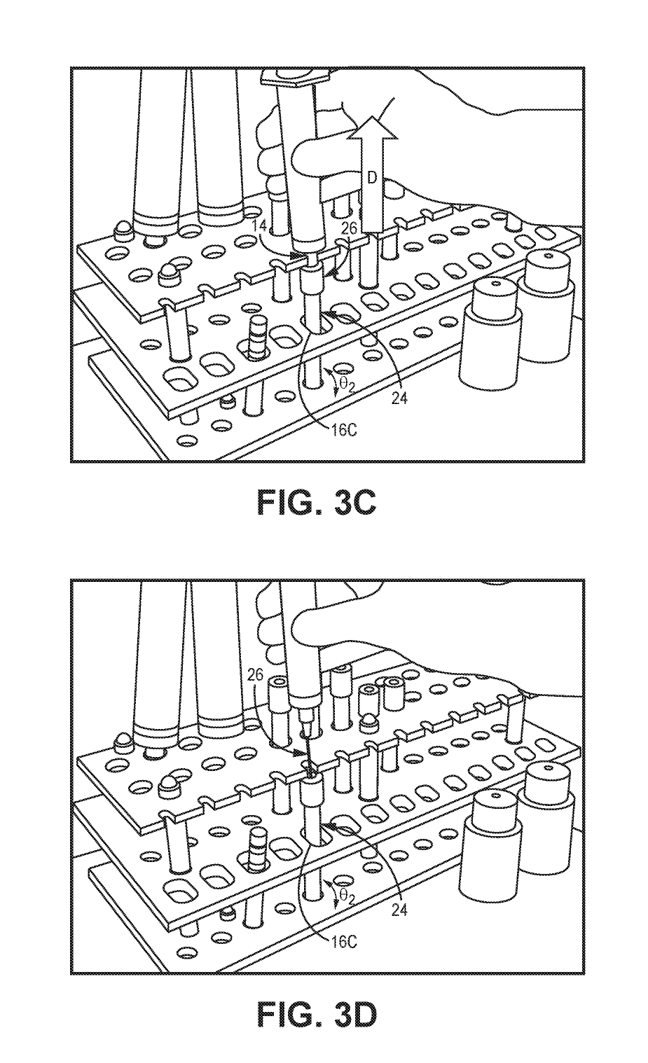

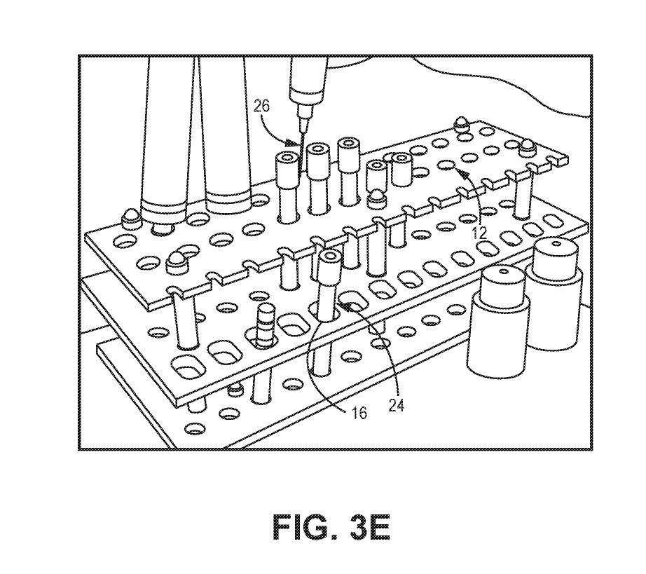

It is understood that in one aspect, the user urges the container 24 via the needle 26. That is, the needle 26 is utilized as a mechanism to rotate or otherwise shift the container 24 into the second, or substantially vertical, position θ₂ shown in the implementations of FIG. 2B and FIG. 2C. In a subsequent step, and as shown in FIG. 2C, the user urges the needle 26 proximally to remove the needle 26 from the container 24, shown by reference arrow D. Further aspects of this process are shown in the implementations of FIGS. 3A-3E

It is understood that when in the angled position θ₁ the axis (I°) of the container 24 is non-coaxial with the notch-to-depression axis (II°) defined by the notch 14 and depression center, while in the substantially vertical position θ₂ the axis (I°) of the container 24 is coaxial with the notch-to-depression axis (II°), as is shown in FIG. 2A, FIG. 2B and FIG. 2C.

The movement of the container 24 from the first, or angled position θ₁ of FIG. 2A to the second, or substantially vertical position θ₂ of FIG. 2B is further captured by the sequence of drawings at FIGS. 3A-3E.

Beginning with FIG. 3A, the user begins by inserting the needle 26 into the container 24, shown by reference arrow B. In this implementation, the container 24 has been placed in the first, or angled position θ₁, as would be understood.

Continuing to use according to the implementation of FIG. 3B, to urge the container 24 into the second, or substantially vertical, position θ₂, the user positions the needle 26 so as to be disposed within the notch 14 of the first shelf 30, shown by reference arrow C.

Turning to FIG. 3C, in certain of these implementations, the notch 14 is sized so as to be sufficiently large so as to accommodate the needle 26. That is, in various non-limiting examples, the notches 14 are sized so as to accommodate needles 26 of a range of sizes, such as about 5Ø or 00000 Birmingham gauge to about 36 Birmingham gauge; from about 13 mm or more to less than 0.1 mm; or, in various implementations the sizes of other understood surgical sizes for needles and/or catheters, such as from about 3 to about 34 French. It would be readily apparent to one of skill in the art how to appropriately size the notches 14 so as to accommodate the needles 26.

As such, in these steps, when the user urges the needle 26 proximally to remove the needle 26 from the container 24, shown by reference arrow D, the container 24 remains in the test tube rack 10/frame 22.

As shown in FIG. 3D, it is understood that the needle 26 can therefore be removed from the container 24 without the user needing to use another device such as a human hand to hold the container in place.

Moving on to FIG. 3E, after the needle 26 is removed from the container 24, the container 24 will revert from the second, or substantially vertical, position θ₂ to the first, or angled position θ₁ via gravity. The container 24 can then optionally be removed from the opening 16 and placed into a storage opening 12. Alternate implementations are of course possible.

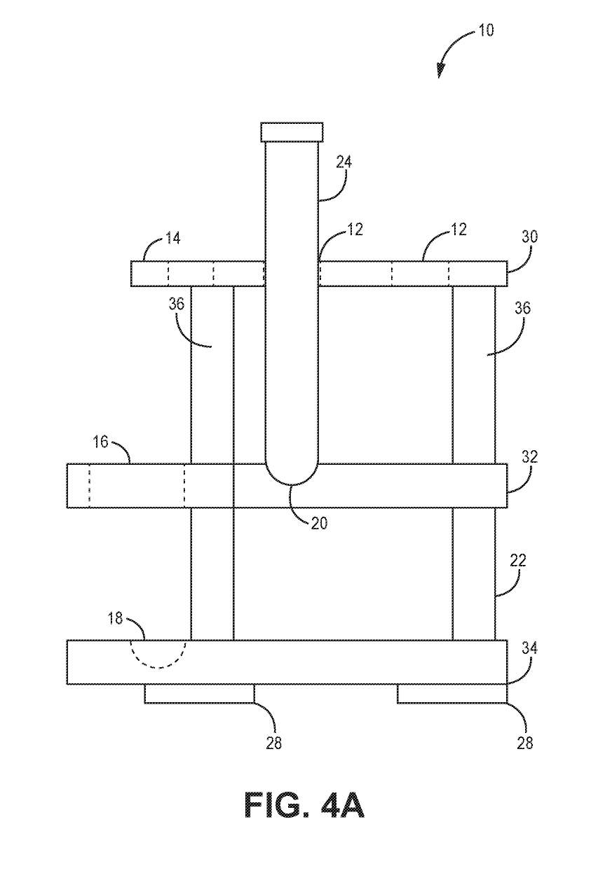

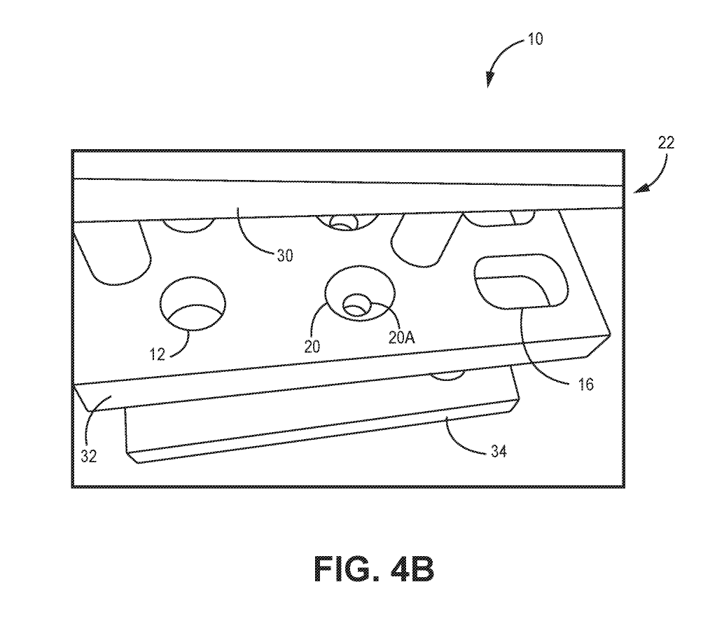

As shown in FIG. 4A and FIG. 4B, in certain non-limiting implementations, the first shelf 30 comprises storage openings 12 where the containers 24 and needles 26 can be placed when not in use. The second shelf 32 comprises storage depressions 20 disposed substantially vertically below the storage openings 12 on which the second end of the container 24 can rest. In certain other implementations, the second shelf 32 does not contain storage depressions 20 but may contain corresponding openings for storage of containers, syringes and needles, as would be understood. As shown in the implementation of FIG. 4B, certain storage depressions 20 define storage depression openings 20A constructed and arranged to allow the flow of air and/or fluid therethrough.

In various implementations of the rack 10, and as shown in FIG. 4A and FIG. 4B, the third shelf 34 also comprises fasteners 28 for attaching the rack frame 22 to a work station, as was shown in FIG. 1. A work station 100 can be but is not limited to a desk, a laboratory bench, or a countertop. These fasteners 28 for attachment can be but are not limited to being magnets. It is understood that in various implementations, the work surface 1 is fitted with paired magnets to allow magnetic communication with each of the rack magnets 28 for securement of the rack 10, and, consequently, increased safety. That is, in these implementations, the rack magnets 28 are configured and arranged to pair with magnets embedded in the work surface. For example, in an exemplary implementation, the work surface 100 can have four magnets spaced in such a way so as to match the magnets 28 disposed on the underside of the third shelf 34. Further, in alternate implementations, the work surface 100 itself can be magnetic. In yet further surfaces, the rack can be fixedly attached to the work surface 100, or selectively attachable and/or securable to the work surface 100 by devices and systems known in the art, or would be readily appreciated, including known fastening systems and devices used in industrial, commercial and/or residential workspaces.

It is understood that securing the rack 10 to a work surface 100 provides several advantages, particularly as it relates to one-handed removal of the needle 26.

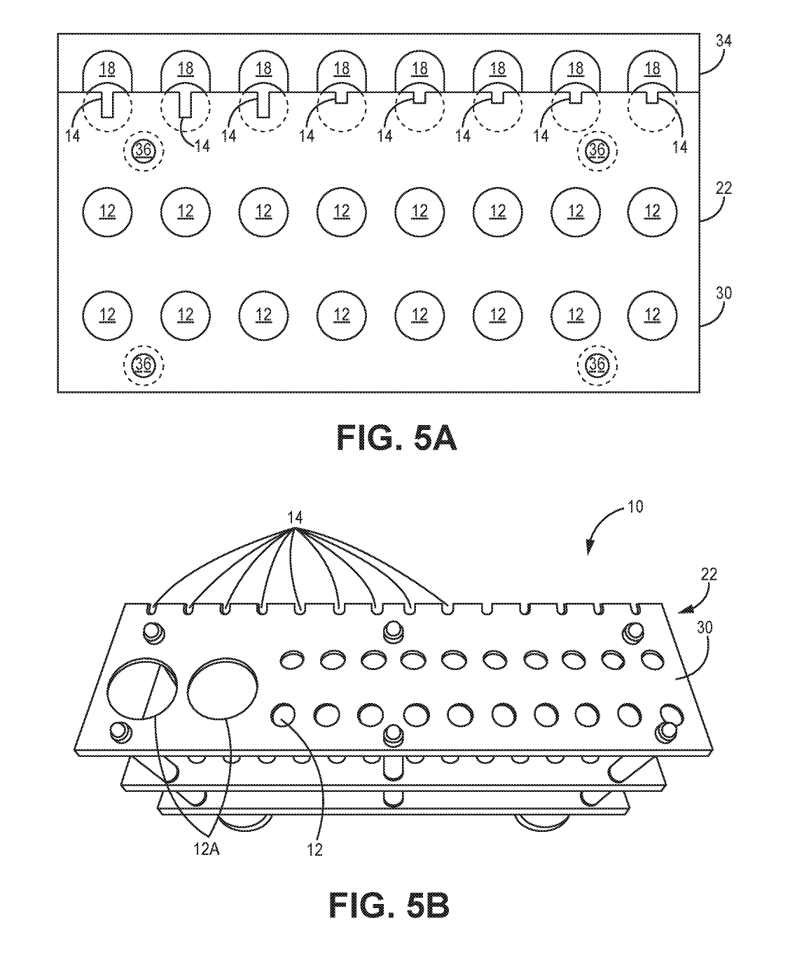

FIG. 5A shows an implementation of an eight-row test tube rack 10/frame 22 from a top perspective. The test tube rack 10/frame 22 has eight notches 14 that correspond to the hemispherical depressions 18 and elongate container openings 16 in which containers 24 can be placed. In certain implementations the first shelf 30 has two rows of storage openings 12, although in various implementations the test tube rack 10/frame 22 may have zero, one, or more than two rows of storage openings 12. The number of rows of storage openings 12 may, but need not necessarily, correspond to the number of notches 14. In various implementations, the supports 36 may attach to the top of the first shelf 30. A further top view is shown in FIG. 5B.

Although the disclosure has been described with reference to preferred implementations, persons skilled in the art will recognize that changes may be made in form and detail without departing from the spirit and scope of the disclosed apparatus, systems and methods.

What is claimed is:

1. A test tube rack system for preventing needle sticks, comprising a frame comprising:
a) a first shelf comprising a plurality of notches defined therein;
b) a second shelf comprising a plurality of openings defined therein and disposed below the plurality of notches; and
c) a third shelf disposed below the plurality of openings and plurality of notches,
wherein the plurality of notches and plurality of openings are constructed and arranged so as to define angled and substantially vertical axes and permit the movement of a container from a first, angled position to a second, substantially vertical position.

2. The test tube rack system of claim 1, wherein each of the plurality of notches is sized to accommodate the passage of a needle but not a container.

3. The test tube rack system of claim 1, wherein one or more supports maintains spacing between the one or more shelves

4. The test tube rack system of claim 1, wherein the frame is constructed and arranged to hold one or more containers in place while a needle is withdrawn from the container.

5. The test tube rack system of claim 1, wherein the system is constructed and arranged for the deposit or withdraw of a sample into the container at the first position or second position.

6. The test tube rack system of claim 1, wherein the plurality of openings each comprise proximal and distal ends.

7. The test tube rack system of claim 6, wherein the rack system is constructed and arranged such that the container will be adjacent to one proximal end in the angled position and be adjacent to one distal end in the vertical position.

8. The test tube rack system of claim 1, wherein the third shelf comprises a plurality of depressions defined therein and disposed below the plurality of elongate openings.

9. A test tube rack, comprising:
a) a frame comprising a first shelf, a second shelf, and a third shelf disposed substantially in parallel;
b) at least one notch defined in the first shelf;
c) at least one opening defined in the second shelf having proximal and distal ends; and
d) at least one depression defined in the third shelf,
wherein each of the at least one openings are constructed and arranged to define an angled container axis with the each of the at least one depressions when a container is adjacent to the at least one openings proximal end, and
wherein each of the at least one notches, at least one openings and at least one depressions is aligned to define a substantially vertical container axis when a container is adjacent to the at least one opening distal opening end.

10. The rack of claim 9, wherein the at least one notch is constructed and arranged to permit withdrawal of a needle without allowing a container to pass through the notch.

11. The rack of claim 9, further comprising at least one fastener constructed and arranged to permit secure attachment to a work surface.

12. The rack of claim 11, wherein the at least one fastener is magnetic.

13. The rack of claim 11, wherein the at least one fastener is magnetic.

14. A system for preventing needle sticks, comprising a rack comprising:
a) a first shelf comprising a plurality of notches defined therein; and
b) a second shelf comprising a plurality of openings defined therein and disposed below the plurality of notches,
wherein the rack is constructed and arranged for use via:
a) inserting a container through one of the elongate openings at an angled position;
b) inserting a needle into the container;
c) urging the container into a substantially vertical position such that the needle enters one of the plurality of notches; and
d) withdrawing the needle from the container via the notch.

15. The system of claim 14, wherein the rack further comprises a third shelf defining a plurality of depressions.

16. The system of claim 15, wherein the plurality of notches, plurality of openings and plurality of depressions are constructed and arranged so as to define angled and substantially vertical axes and permit the movement of the container.

17. The system of claim 14, wherein the rack comprises a plurality of magnets constructed and arranged to secure the rack to a work space.

18. The system of claim 14, wherein the second shelf further comprises a plurality of storage depressions.

19. The system of claim 18, wherein the first shelf further defines one or more openings disposed above the plurality of storage depressions and constructed and arranged to secure the container.

20. The system of claim 14, wherein each of the plurality of notches is sized to accommodate the passage of a needle but not a container.
